(19) United States
(12) Patent Application Publication
(10) Pub. No.: US 2005/0242495 A1
(43) Pub. Date: Nov. 3, 2005

(54) Paper discharge device for printer

(76) Inventor: Kouichi Chikumoto, Osaka (JP)

Correspondence Address: LORUSSO, LOUD & KELLY, 3137 Mount Vernon Avenue, Alexandria, VA, 22305, US

(21) Appl. No.: 11/085,566

(22) Filed: Mar. 22, 2005

(30) Foreign Application Priority Data
Apr. 28, 2004 (JP) 2004-132692

(51) Int. Cl. B65H 5/00; G03G 21/00

(52) U.S. Cl. 271/264

(57) ABSTRACT

A paper discharge device for printer according to the present invention has a paper guide 4 that comprises a paper holding portion 41 for holding paper P with a paper guide surface 3 therebetween at a longitudinally intermediate position A of the paper guide surface 3 in front of a paper feed roller 1 while the paper P passes therethrough in the feed direction “a”. The paper guide 4 is formed by a resin plate piece, one surface of the plate piece being utilized as a paper discharge surface 42. An extension portion 43 included in the plate piece is provided opposite below a paper discharge roller 5 to bring upward the paper P running on to the paper discharge surface 42 into contact with the circumferential surface 51 of the paper discharge roller 5 by the elasticity of the plate piece. Thus, one surface of the paper guide is utilized as a paper discharge surface, and the paper guide is also used as a paper pressing member for pressing paper against the paper discharge roller.

### BACKGROUND OF THE INVENTION

1. (Field of the Invention)

The present invention relates to a paper discharge device for printer, and more particularly to a paper discharge device for printer adapted to bring paper into elastic contact with a paper discharge roller to apply a carrying force to the paper in the discharge direction.

2. (Description of the Prior Art)

In FIG. 4 is shown a schematic side elevational view of a conventional paper discharge device. In the paper discharge device shown in the figure, on the upper surface of a base member 2 with a paper feed roller 1 mounted thereon is formed a paper guide surface 3 for guiding paper, which is fed by the paper feed roller 1 in the feed direction (forward) “a”, slidingly toward a print section (not shown in the figure), and from a bearing portion 21 of the base member 2, which holds rotatably a spindle 12 supporting the paper feed roller 1, through a longitudinally intermediate position A of the paper guide surface 3 is arranged a paper guide 4 formed by a plate piece with the rear portion thereof raised, the front end portion of the paper guide 4 being brought into elastic contact with the paper guide surface 3 as a paper holding portion 41. Also, a paper discharge roller 5 is provided above the paper feed roller 1, and above the paper discharge roller 5 is provided a paper pressing member 6 formed using a plate spring, etc., the paper pressing member 6 being brought downward into elastic contact with the circumferential surface 51 of the paper discharge roller 5 by the elasticity thereof. Further, one surface (upper surface) of the paper guide 4 is formed as a paper discharge surface 42 that allows paper carried through on the paper guide surface 3 in front of the paper holding portion 41 in the discharge direction (rearward) “b” opposite to the feed direction “a” to run on thereto.

In a printer equipped with the paper discharge device having the arrangement above, paper fed by the paper feed roller 1 is kept held between the paper guide surface 3 and the paper holding portion 41 formed in the front end portion of the paper guide 4 at the longitudinally intermediate position A of the paper guide surface 3 in front of the paper feed roller 1 while the paper passes therethrough in the feed direction “a” to be sent into the print section. After printing in the print section, the paper is carried through on the paper guide surface 3 in front of the paper holding portion 41 in the discharge direction “b”. Then, the paper P carried through on the paper guide surface 3 in the discharge direction “b” is scooped up by the paper holding portion 41 thereon to run on to the paper discharge surface 42, and then slides through on the paper discharge surface 42 to be introduced between the paper discharge roller 5 and the paper pressing member 6. Therefore, the paper P is brought downward into elastic contact with the circumferential surface 51 of the paper discharge roller 5 by the elasticity of the paper pressing member 6, and then a carrying force in the discharge direction “b” is applied to the paper P by the paper discharge roller 5 to discharge the paper P rearward.

In such a paper discharge device, in the case where a single motor (not shown in the figure) is required as a rotary drive source for the paper feed roller 1 and the paper discharge roller 5 to limit the required number of motors to one, two examples as shown in FIGS. 5(A) and 5(B) can be cited as a transmission mechanism for operating the paper feed roller 1 and the paper discharge roller 5 simultaneously. In the transmission mechanism shown in FIG. 5(A), a relay gear 73 is provided between an input gear 71 on the side of the paper feed roller 1 and an output gear 72 on the side of the paper discharge roller 5, whereby the paper feed roller 1 and the paper discharge roller 5 are adapted to rotate in the same direction of R1 and R2 respectively to feed and discharge paper without switching the rotation direction of the motor. Meanwhile, in the transmission mechanism shown in FIG. 5(B), the input gear 71 on the side of the paper feed roller 1 and the output gear 72 on the side of the paper discharge roller 5 are engaged directly with each other, whereby the paper feed roller 1 and the paper discharge roller 5 are adapted to rotate in the opposite direction of R1 and R2 respectively to select the feed mode or the discharge mode alternatively by switching the rotation direction of the motor. It is noted that the arrow R1′ indicates the rotation direction of the input gear 71 on the side of the paper feed roller 1 in the feed mode, while the arrow R2′ indicates the rotation direction of the output gear 72 on the side of the paper discharge roller 5 in the feed mode.

Among antecedents relating to a paper discharge device, there exist many ones, in which paper is brought into elastic contact with a paper discharge roller using a member corresponding to the paper pressing member 6 shown in FIG. 4, and then the paper discharge roller is rotated to apply a carrying force to the paper in the discharge direction (refer to Japanese Utility-Model Laid-Open Publication No. Sho 61-130442, Japanese Patent Laid-Open Publication No. Hei 2-32880, and Japanese Utility-Model Laid-Open Publication No. Hei 6-36850).

However, the arrangement, as shown in the prior art example described in FIG. 4 or the above-described antecedents, that paper is brought into elastic contact with the paper discharge roller 5 using the paper pressing member 6 or a member corresponding thereto, and then the paper discharge roller 5 applies a carrying force to the paper in the discharge direction requires the paper pressing member 6 or the member corresponding thereto additionally, resulting in a cost increase and in a problem in that it is necessary to ensure an additional space for installing the paper pressing member 6, inhibiting the reduction of the size of the paper discharge device.

Also, in the case, as shown in the prior art example, where with the arrangement that the paper P is introduced over the paper discharge roller 5 to be brought downward into elastic contact with the circumferential surface 51 of the paper discharge roller 5 by the paper pressing member 6, a single motor is required as a rotary drive source for the paper feed roller 1 and the paper discharge roller 5 to limit the required number of motors to one, it is necessary to provide the relay gear 73 additionally between the input gear 71 on the side of the paper feed roller 1 and the output gear 72 on the side of the paper discharge roller 5 as described with reference to FIG. 5(A) to feed and discharge paper without switching the rotation direction of the motor, resulting in an increase in the number of required parts and thereby the cost increases and in a problem in that it is necessary to ensure an additional space for installing the relay gear 73, inhibiting the reduction of the size of the paper discharge device. On the contrary, selecting the feed mode and the discharge mode alternatively by switching the rotation direction of the motor suffers from a problem in that the technique for controlling the rotation direction of the motor becomes complicated.

### SUMMARY OF THE INVENTION

The present invention has been made in consideration of the above-mentioned problems, and an object thereof is to provide a paper discharge device for printer, in which one surface of a paper guide is utilized as a paper discharge surface for guiding paper in the discharge direction, and the paper guide is also used as a replacement for the paper pressing member 6 described in FIG. 4 to allow the paper pressing member 6 as an additional part to be removed.

It is another object of the present invention to provide a paper discharge device for printer, in which in the case where a single motor is required as a rotary drive source for the paper feed roller 1 and the paper discharge roller 5 to limit the required number of motors to one, the arrangement of a transmission mechanism between the paper feed roller and the paper discharge roller for feeding and discharging paper without switching the rotation direction of the motor can be simplified easily.

A paper discharge device for printer according to the present invention has a paper guide that comprises a paper holding portion for holding paper fed by a paper feed roller with a paper guide surface therebetween at a longitudinally intermediate position of the paper guide surface in front of the paper feed roller while the paper passes therethrough in the feed direction. Then, the paper guide is formed by an elastic plate piece, one surface of the plate piece being formed as a paper discharge surface that allows paper carried through on the paper guide surface in front of the paper holding portion in the discharge direction opposite to the feed direction to run on thereto, and the plate piece including a paper pressing portion for bringing the paper running on to the paper discharge surface into elastic contact with a paper discharge roller for applying a carrying force to the paper in the discharge direction by the elasticity of the plate piece while the paper passes therethrough. A resin plate may preferably be used for the plate piece.

In accordance with the invention above, the plate piece forming the paper guide includes the paper pressing portion, which is adapted to bring paper running on to the paper discharge surface formed by one surface of the plate piece into elastic contact by the elasticity of the plate piece, whereby the function offered by the paper pressing member 6 described in FIG. 4 is to be offered by the paper pressing portion of the paper guide instead. Therefore, it is not necessary to use the paper pressing member 6 as an additional part, resulting in a reduction of the number of parts, and also to ensure an additional space for installing the paper pressing member 6.

Further in accordance with the arrangement above, the paper running on to the paper discharge surface is brought upward into elastic contact with the circumferential surface of the paper discharge roller, whereby in the case where a single motor is required as a rotary drive source for the paper feed roller and the paper discharge roller to limit the required number of motors to one, it is possible to feed and discharge paper without switching the rotation direction of the motor by engaging an input gear on the side of the paper feed roller and an output gear on the side of the paper discharge roller directly with each other. Therefore, it is not necessary to use additionally the relay gear 73 shown in FIG. 5(A) with respect to the conventional paper discharge device, resulting in a reduction of the number of parts, and also to ensure an additional space for installing the relay gear 73, which allows the reduction of the size of the paper discharge device to be promoted easily. In addition, it is not necessary to select the feed mode or the discharge mode alternatively by switching the rotation direction of the motor as described with reference to FIG. 5(B).

A paper discharge device according to the present invention can be specified more clearly by employing the arrangement that in the paper discharge device for printer having a paper guide that comprises a paper holding portion for holding paper fed by a paper feed roller with a paper guide surface therebetween at a longitudinally intermediate position of the paper guide surface in front of the paper feed roller while the paper passes therethrough in the feed direction, the paper guide is formed by a flat plate piece composed of an elastic resin plate, one surface of the plate piece being formed as a paper discharge surface that allows paper carried through on the paper guide surface in front of the paper holding portion in the discharge direction opposite to the feed direction to run on thereto, and the plate piece being provided from the paper guide surface through above the paper feed roller with the rear portion thereof raised, and a paper discharge roller for applying a carrying force to the paper running on to the paper discharge surface in the discharge direction is provided opposite above an extension portion included in the plate piece by extending the plate piece rearward, the extension portion including a paper pressing portion for bringing upward the paper running on to the paper discharge surface into elastic contact with the circumferential surface of the paper discharge roller by the elasticity of the plate piece while the paper passes therethrough.

As described heretofore, in accordance with the present invention, one surface of the paper guide is utilized as the paper discharge surface for guiding paper in the discharge direction, and the paper guide is also used as a replacement for the paper pressing member 6 described in FIG. 4 to allow the paper pressing member 6 as an additional part to be removed, resulting in a reduction of the number of parts, and it is not necessary to ensure an additional space for installing the paper pressing member 6, which allows the reduction of cost and size of the paper discharge device to be promoted easily.

Further, in the case where a single motor is required as a rotary drive source for the paper feed roller and the paper discharge roller to limit the required number of motors to one, the arrangement of a transmission mechanism between the paper feed roller and the paper discharge roller for feeding and discharging paper without switching the rotation direction of the motor can be simplified easily.

### BRIEF DESCRIPTION OF THE DRAWINGS

FIG. 1 is a schematic side elevational view of a paper discharge device for printer according to the present invention;

FIG. 2 is an enlarged view of a substantial part of the paper discharge device for printer according to the present invention;

FIG. 3 is an illustrative view showing an example of a transmission mechanism;

FIG. 4 is a schematic side elevational view of a prior art example;

FIG. 5(A) is an illustrative view showing an example of a transmission mechanism that can be employed in the prior art example; and

FIG. 5(B) is an illustrative view showing another example of the transmission mechanism.

### DESCRIPTION OF THE PREFERRED EMBODIMENTS

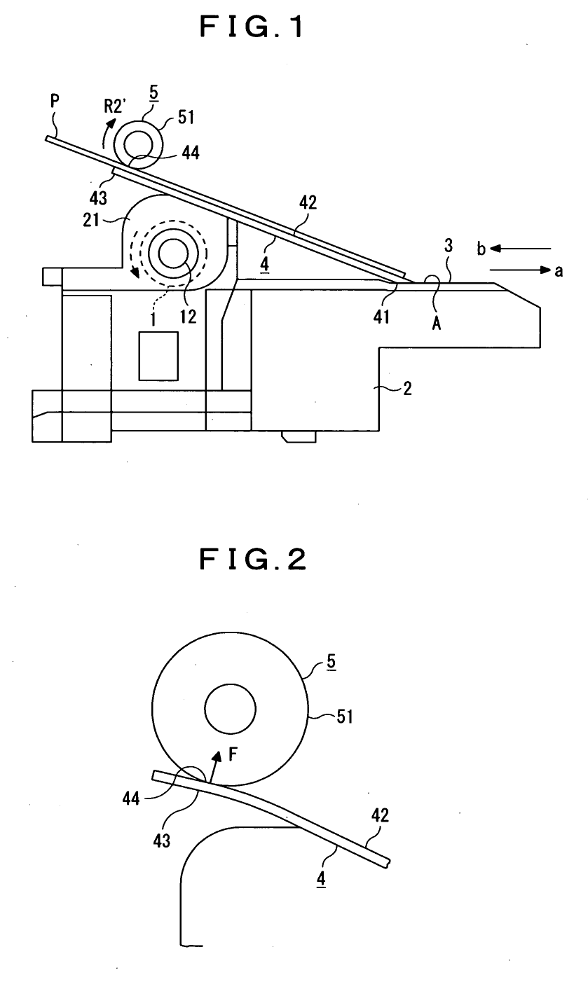

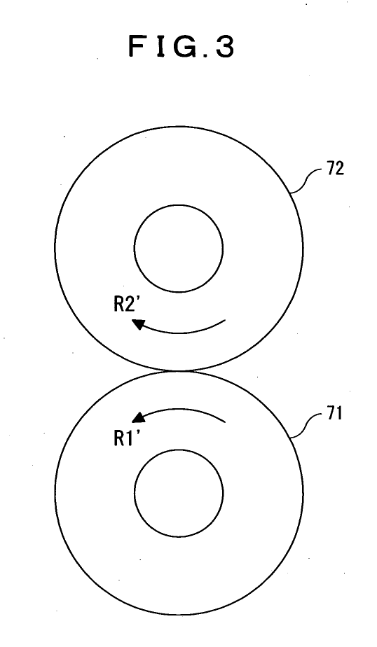

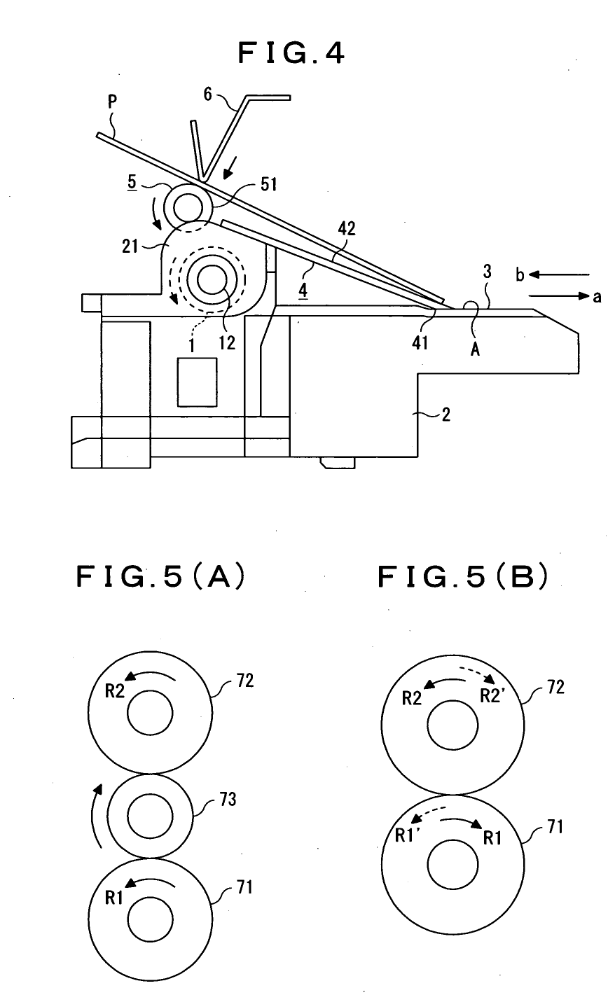

FIG. 1 is a schematic side elevational view of a paper discharge device for printer according to the present invention, FIG. 2 is an enlarged view of a substantial part of the paper discharge device, and FIG. 3 is an illustrative view showing an example of a transmission mechanism.

The paper discharge device shown in FIG. 1 has the same arrangement as the prior art example described in FIG. 4 in that on the upper surface of a base member 2 with a paper feed roller 1 mounted thereon is formed a paper guide surface 3 for guiding paper, which is fed in the feed direction (forward) “a” by the paper feed roller 1, slidingly toward a print section (not shown in the figure); that from a bearing portion 21 of the base member 2, which holds rotatably a spindle 12 supporting the paper feed roller 1, through a longitudinally intermediate position A of the paper guide surface 3 is arranged a paper guide 4 formed by a plate piece with the rear portion thereof raised, the front end portion of the paper guide 4 being brought into elastic contact with the paper guide surface 3 as a paper holding portion 41; that one surface (upper surface) of the paper guide 4 is formed as a paper discharge surface 42 that allows paper carried through on the paper guide surface 3 in front of the paper holding portion 41 in the discharge direction (rearward) “b” opposite to the feed direction “a” to run on thereto; and that a paper discharge roller 5 for applying a carrying force to the paper P running on to the paper discharge surface 42 in the discharge direction is provided.

The present embodiment is different from the prior art example described in FIG. 4 in that the paper pressing member 6 of the prior art example is removed to utilize the paper guide 4 instead. That is, in the present embodiment, the paper guide 4 is formed by a flat plate piece composed of an elastic resin plate, and the paper discharge roller 5 is provided opposite above an extension portion 43 included in the plate piece by extending the plate piece rearward beyond the bearing portion 21, the extension portion 43 including a paper pressing portion 44 for bringing upward the paper P running on to the paper discharge surface 42 formed by one surface of the paper guide 4 into elastic contact with the circumferential surface 51 of the paper discharge roller 5 by the elasticity of the plate piece while the paper P passes therethrough. When no paper exists, the paper pressing portion 44 is brought upward into elastic contact with the circumferential surface 51 of the paper discharge roller 5 as shown in FIG. 2.

In the paper discharge device according to the arrangement above, since the paper holding portion 41 formed in front of the paper guide 4 is brought into elastic contact with the paper guide surface 3, even in the case where multiple sheets of paper are carried in an overlapping manner through on the paper guide surface 3, only one sheet of paper is held separately between the paper holding portion 41 and the paper guide surface 3 to pass therethrough. Therefore, the paper guide 4 offers a function of preventing paper from being carried in an overlapping manner.

In addition, when printed paper is carried through on the paper guide surface 3 in the discharge direction “b”, the paper runs on to the paper discharge surface 42 of the paper guide 4, and then the leading end of the paper P proceeds into the clearance between the paper pressing portion 44 and the paper discharge roller 5. Then, when the leading end of the paper P proceeds into the clearance between the paper pressing portion 44 and the paper discharge roller 5, the paper P is to be pressed upward against the circumferential surface 51 of the paper discharge roller 5 by the elasticity of the extension portion 43 included in the plate piece composed of a resin plate and forming the paper guide 4. The pressing direction in this case is shown in FIG. 2 by the arrow F. Thus, a carrying force is to be applied to the paper P in the discharge direction by the rotation of the paper discharge roller 5 in the discharge direction (arrow R2′), and therefore the paper P pressed against the paper discharge roller 5 by the paper pressing portion 44 to be brought into elastic contact with the paper discharge roller 5 passes through the elastic contact area, that is, the clearance between the paper discharge roller 5 and the paper pressing portion 44 to be discharged rearward.

In such a paper discharge device, in the case where a single motor (not shown in the figure) is required as a rotary drive source for the paper feed roller 1 and the paper discharge roller 5 to limit the required number of motors to one, an example shown in FIG. 3 can be employed as a transmission mechanism for operating the paper feed roller 1 and the paper discharge roller 5 simultaneously. In the transmission mechanism shown in FIG. 3, the paper feed roller 1 and the paper discharge roller 5 are adapted to rotate in the opposite direction of R1′ and R2′ respectively by engaging an input gear 71 on the side of the paper feed roller 1 and an output gear 72 on the side of the paper discharge roller 5 directly with each other. In accordance with the transmission mechanism, it is possible to feed and discharge paper without switching the rotation direction of the motor. Therefore, no complicated control of selecting the feed mode and the discharge mode alternatively by switching the rotation direction of the motor is required.

The paper guide 4 may be provided horizontally, though provided with the rear portion thereof raised in the present embodiment. The plate piece forming the paper guide 4 may also be made of an elastic steel plate instead of resin plate.

1. A paper discharge device for printer having a paper guide that comprises a paper holding portion for holding paper fed by a paper feed roller with a paper guide surface therebetween at a longitudinally intermediate position of said paper guide surface in front of said paper feed roller while said paper passes therethrough in the feed direction, wherein said paper guide is formed by a flat plate piece composed of an elastic resin plate, one surface of said plate piece being formed as a paper discharge surface that allows paper carried through on said paper guide surface in front of said paper holding portion in the discharge direction opposite to the feed direction to run on thereto, and said plate piece being provided from said paper guide surface through above said paper feed roller with the rear portion thereof raised, and wherein a paper discharge roller for applying a carrying force to said paper running on to said paper discharge surface in the discharge direction is provided opposite above an extension portion included in said plate piece by extending said plate piece rearward, said extension portion including a paper pressing portion for bringing upward said paper running on to said paper discharge surface into elastic contact with the circumferential surface of said paper discharge roller by the elasticity of said plate piece while said paper passes therethrough.

2. A paper discharge device for printer having a paper guide that comprises a paper holding portion for holding paper fed by a paper feed roller with a paper guide surface therebetween at a longitudinally intermediate position of said paper guide surface in front of said paper feed roller while said paper passes therethrough in the feed direction, wherein said paper guide is formed by an elastic plate piece, one surface of said plate piece being formed as a paper discharge surface that allows paper carried through on said paper guide surface in front of said paper holding portion in the discharge direction opposite to the feed direction to run on thereto, and said plate piece including a paper pressing portion for bringing said paper running on to said paper discharge surface into elastic contact with a paper discharge roller for applying a carrying force to said paper in the discharge direction by the elasticity of said plate piece while said paper passes therethrough.

3. The paper discharge device for printer according to claim 2, wherein said plate piece is composed of a resin plate.

4. The paper discharge device for printer according to claim 2, wherein said plate piece is provided from said paper guide surface through above said paper feed roller with the rear portion thereof raised, said paper pressing portion being included in an extension portion included in said plate piece by extending said plate piece rearward.

5. The paper discharge device for printer according to claim 3, wherein said plate piece is provided from said paper guide surface through above said paper feed roller with the rear portion thereof raised, said paper pressing portion being included in an extension portion included in said plate piece by extending said plate piece rearward.
